(19) United States
(12) Patent Application Publication
(10) Pub. No.: US 2008/0209794 A1
(43) Pub. Date: Sep. 4, 2008

(54) Fish hook made of an in situ composite of bulk-solidifying amorphous alloy

(76) Inventor: Mark C. Anderson, Minnetonka, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 12/070,058

(22) Filed: Feb. 14, 2008

Related U.S. Application Data
(60) Provisional application No. 60/901,231, filed on Feb. 14, 2007.

(51) Int. Cl. A01K 83/00

(52) U.S. Cl. 43/43.16; 29/9

(57) ABSTRACT

A fish hook formed at least in part of a composite material comprising: an amorphous metal alloy forming a substantially continuous matrix; and a second ductile metal phase embedded in the matrix and formed in situ in the matrix by crystallization from a molten alloy. A method of making a fish hook. A method of fishing.

### PRIORITY

The present non-provisional patent application claims benefit from United States Provisional Patent Application having Ser. No. 60/901,231, filed on Feb. 14, 2007, by Anderson, and titled FISH HOOK MADE OF AN IN SITU COMPOSITE OF BULK-SOLIDIFYING AMORPHOUS ALLOY, wherein the entirety of said provisional patent application is incorporated herein by reference.

### FIELD OF THE INVENTION

The present invention relates generally to fish hooks, and more particularly relates to fish hooks made at least in part of an in situ composite of bulk-solidifying amorphous alloy.

### BACKGROUND OF THE INVENTION

For quite some time, there has been a demand for open-ocean fish such as tuna (e.g., bluefin, yellowfin, bigeye, and albacore), swordfish, mahi-mahi, shark, and the like. Such open-ocean fish can grow to hundreds of pounds and are known for their fighting strength. Harvesting such open-ocean fish has been and continues to be commercially significant.

Because of the size and strength of many open-ocean fish, commercial fishing equipment needs to be relatively large and heavy duty. Indeed, commercial fishing hooks are significantly larger and more heavy duty than metal wire hooks used to fish small fresh-water fish such as bluegill and the like. FIG. 1 shows an example of a typical commercial fishing fish hook. Fish hook 10 includes an eye 15, shank 25, bend 30, point 35, and barb 40. In general, two important dimensions of a fish hook are the gape 45 and/or the bite/throat 46. These features are discussed further below. Fish hook 10 is commonly made out of a high strength material such as conventional metal formulations (e.g., stainless steel) and is relatively large (e.g., such as the saltwater hooks available from VMC Inc., Saint Paul, Minn., USA).

One would think that a conventional fish hook could be fabricated simply and in one piece. This is not the case, because such hooks lack the strength, durability, impact resistance, and/or deformation resistance to be practically useful. The integrity of the hooks is further confounded by the tendency of conventionally used metal formulations to be relatively incompatible as much as might be desired with respect to one-step fabrication processes, e.g., injection molding, casting processes, and the like. As one problem, the formed part tends to shrink too much and/or develop too much porosity upon cooling. It is believed that this occurs in that conventionally used molten metal goes through a liquid-to-solid transformation that can result in a sudden, discontinuous volume change upon solidification. Whatever the mechanism, the resulting part may suffer from low metallurgical soundness and quality.

Molding and casting problems are severe enough that, notwithstanding the added manufacturing complexity, commercial fishing hooks are typically manufactured in multiple steps (even 7 distinct steps is typical) by forming and attaching (e.g., welding) two or more parts together to form a fish hook. For example, as shown, hook 10 includes a welded joint 20 that joins together eye 15 to shank 25. Stainless steel hooks may include even more than two individual pieces attached together to form a hook. Typically, after welding, a fish hook is heat-treated. Such multi-step manufacturing of commercial fishing hooks can reduce and/or complicate manufacturing yield. The extra steps also significantly increase manufacturing time and cost.

The use of multiple parts and multi-step manufacturing limits design flexibility in that it becomes uneconomical for a fish hook manufacturer to invest in tooling for additional fish hook designs. It would be very desirable to simplify the manufacture of fish hooks. It would also be desirable to ease the economics of developing and manufacturing additional fish hook designs.

Commercial harvesting of open-ocean fish can be performed using a variety of fishing techniques, e.g., trotlines and longlines/trawl lines/setlines. Longline fishing combines the quality of “one-at-a-time-handling” fishing technique with the efficiency of the “hook-and-line” longlining fishing technique. Longline fishing for open-ocean fish species on a commercial scale can include attaching thousands of baited hooks to one or more fishing lines. These lines are coupled to one or more fishing vessels that patrol a desired fishing territory, pulling these lines astern.

During commercial fishing, the efficiency of a particular fishing method is desirably as high as possible to save time and money to the fisherman and ultimately to save money to the consumer. Efficiency can be measured by one or more criteria such as average fish caught per line per unit time (line efficiency), average fish caught per gallon of fuel consumed (fuel efficiency), average fish caught per unit time (time efficiency), average fish caught per hook per unit time (hook efficiency), and/or the like. These efficiencies are impacted by a variety of factors.

For example, a longline fishing line typically includes at least one mainline with secondary lines branching off of the mainline. Baited hooks (e.g., hook 10) are set far apart from each other on the fishing line. Monofilament fishing line is preferred as it tends to reduce drag. It is also lightweight and strong. These features are important, because some longlines can be up to 7 miles, up to 30 miles, even up to 80 miles, long and carry up to, e.g., 10,000 hooks similar to hook 10. These line(s) are towed below the surface of water astern fishing vessels so that large numbers of open-ocean fish can be caught. Because of the large number of conventional metal hooks involved, the cumulative weight of the lines and hooks is tremendous and significantly impacts fuel usage by the towing vessel. It would be desirable to help reduce the impact that these lines have upon fuel usage. This could extend the range of a vessel and/or lower fishing costs overall.

Additionally, hooks are damaged and/or lost for one reason or another, requiring replacement. Hooks fail for a variety of reasons. For example, many of the materials (e.g., stainless steel) conventionally used to make fish hooks start to corrode soon after being exposed to the open-ocean waters (i.e., salt-water). Many of the fine features of a hook responsible for hooking and holding a fish (e.g., point 35 and barb 40) quickly corrode to a point such that their ability to penetrate and/or hold a fish is reduced or lost. A severely corroded hook is also more prone to damage and/or loss.

As another example, the many points of attachment (e.g., weld 20) among parts in many conventional fish hooks can create points of weakness such that when a large open-ocean fish (e.g., tuna) hits the hook with sufficient force, the hook may unduly bend or completely fail (i.e., break) at the point or points of weakness causing the fish hook utility to be reduced or lost. A common cause of losing a hook similar to hook 10 in tuna fishing is by a tuna hitting hook 10 with sufficient force such that hook breaks at weld 20 causing the lower part of hook 10 to fall from the fishing line.

Apart from attachment points, the impact resistance of conventional metal parts themselves (e.g., stainless steel fish hooks) may be such that a large fish such as a tuna can sometimes impact the hook with such force that the hook literally snaps apart and falls from the fishing line. In such a case, the utility of the fish hook is completely lost.

The metal material (e.g., stainless steel) of many conventional commercial fish hooks can be susceptible to undue, permanent deflection upon impact by an open-ocean fish species such as a large tuna. Many times, when a large ocean fish such as a tuna hits a conventional metal hook (e.g., to take the bait), the tuna hits the hook with sufficient force to cause significant deflection or other deformation (e.g., up to 90 degrees or more). Deflecting to an undue degree causes the utility of the hook for catching a fish to be reduced or lost. The resulting deformation tends to be permanent unless the hook is removed from service for replacement or repair. Conventional metal hooks tend to lack the memory required for the hook to naturally return to a position such that the hook's utility is regained.

If the utility of a hook is lost or reduced to an undue degree, a new hook is desirably attached to the line to replace the old hook. Replacing hooks can involve significant labor, material, down time, and other costs, which ultimately increases the cost to a consumer. The costs associated with attaching and replacing, as needed, many hooks is significant. It would be desirable to reduce the labor, materials, costs, and down time associated with maintaining lines so that a vessel and its crew can spend more time fishing and less time getting ready to fish.

A metallic glass has been disclosed in a copending application as a material useful for fishing hooks that is stronger than conventional materials. The copending U.S. patent application has Ser. No. 11/013,261, was filed Dec. 14, 2004, by Anderson, and is titled “Fish Hook and Related Methods.” The metallic glass material disclosed may be stronger than conventional materials used for fish hooks, however the material can be brittle.

Thus, there is a continuing need for new and improved fish hooks, especially commercial fishing fish hooks. In particular, a strong but ductile material is desirable for forming such fish hooks.

An in situ composition of bulk-solidifying amorphous alloy that can be more ductile than metallic glass and at least as strong is described in U.S. Patent Application Publication No. US 2006/0154745 A1, published Jul. 13, 2006, and titled “Golf Club Made of a Bulk-Solidifying Amorphous Metal,” which is herein incorporated by reference in its entirety.

### SUMMARY OF THE INVENTION

In one aspect, the present invention relates to fish hooks made at least in part from an in situ composite of bulk-solidifying amorphous alloy. The in situ composite of bulk-solidifying amorphous alloy comprises a ductile crystalline phase distributed in a fully amorphous matrix. The composite is formed in situ by cooling from a fully molten alloy, wherein the ductile crystalline phase precipitates first upon cooling and then the remaining molten alloy freezes into an amorphous matrix. The ductile crystalline phase is preferably a primary crystalline phase of the main constituent element of the alloy and in dendritic form. Such fish hooks, having such separate phases, results in the hooks having more resiliency than if they had one phase alone.

Fish hooks made from an in situ composite of bulk-solidifying amorphous alloy have many advantages. Firstly, as a consequence of the high yield strength, superior elastic limit, high corrosion resistance, high hardness, superior strength-to-weight ratio, high wear-resistance, and other characteristics associated with amorphous metals, fish hooks made of in situ composite of bulk-solidifying amorphous alloy possess significantly greater strength, durability, impact resistance and “memory” than many conventional fish hooks.

Fish hooks made of such material are stronger and less likely to break or deflect to an undue degree during use. For example, a fish hook made from a conventional metal formulation may permanently deflect 90 or more degrees under a load indicative of the impact upon the hook of large ocean fish, e.g., a tuna. In contrast, a fish hook in accordance with the present invention may deflect only 10 degrees under similar conditions. The hook of the present invention thus retains its utility, while that of the conventional hook would be lost.

Even if a load were severe enough to cause more significant deflection, the fish hooks of the present invention benefit from deformation “memory” (i.e., an ability to return to the original manufactured shape and configuration). In contrast, a conventional hook will tend to permanently deform with an increased risk of lost utility.

Fish hooks made from an in situ composite of bulk-solidifying amorphous alloy can be fabricated, if desired, using casting and molding processes. These can be one-step processes. In addition, these processes can result in fish hooks that are one unitary piece. Unitary fish hooks can increase strength and durability of the hooks because of a lack of attachment points (e.g., weld points) that can be sites of failure. Being able to form a unitary, undivided fish hook of the present invention via, e.g., injection molding, can also increase development and design flexibility of fish hooks.

Because of the superior strength of the material and the available methods of fabrication possible, fish hooks made from the amorphous alloy can also be fabricated with finer and/or smaller structures. Small structures, such as barbs and points, are particularly important to the utility of fish hooks.

The fish hooks of the present invention are also corrosion resistant, even in salt water. This characteristic, too, helps the fish hooks have a longer service life than a fish hook made from a conventional metal formulation. Of particular importance, even fine features such as a point and/or a barb of a fish hook, of the present invention, can resist salt-water corrosion for long periods of time. In contrast, similar fine features of conventional hooks begin to corrode virtually immediately upon immersion in salt water and often show significant corrosion damage after only a few days.

Because the fish hooks of the present invention are less susceptible to damage, on average, the hooks stay in service without need of repair or replacement for longer periods of time. Also, because the hooks are stronger, more impact resistant, and more resistant to deformation, more fish per deployed hook can be caught. Further, because fishermen may spend less time replacing or repairing lost or damaged hooks, more work time can be devoted to actual fishing and less to repair and maintenance of the lines bearing the hooks.

In situ composite of bulk-solidifying amorphous alloy may have a lower density than many conventional metal formulations. Fish hooks including such material therefore can be dramatically lighter than their conventional counterparts. Given the length of fishing longlines and the voluminous numbers of hooks carried by these lines, the cumulative weight savings can be quite significant. Consequently, lines bearing these hooks have a lesser impact upon fuel usage of towing vessels.

Therefore, the fish hooks of the present invention offer substantial improvements in line efficiency, fuel efficiency, time efficiency and hook efficiency of fishing operations.

One embodiment of the first aspect of the present invention is a fish hook formed at least in part of a composite material comprising: an amorphous metal alloy forming a substantially continuous matrix; and a second ductile metal phase embedded in the matrix and formed in situ in the matrix by crystallization from a molten alloy. The second phase may be formed from a molten alloy having an original composition in the range of from 52 to 68 atomic percent zirconium, 3 to 17 percent titanium, 2.5 to 8.5 atomic percent copper, 2 to 7 atomic percent nickel, 5 to 15 percent beryllium, and 3 to 20 percent niobium. The second phase may be sufficiently spaced apart for inducing a uniform distribution of shear bands throughout a deformed volume of the composite, the shear bands involving at least four volume percent of the composite before failure in strain and traversing both the amorphous metal alloy matrix and the second phase. The second phase may be in the form of dendrites. The second phase may have a modulus of elasticity less than the modulus of elasticity of the amorphous metal alloy. The ductile metal particles of the second phase may be sufficiently spaced apart for inducing a uniform distribution of shear bands traversing both the amorphous phase and the second phase and having a width of each shear band in the range of from 100 to 500 nanometers. The second phase may have an interface in chemical equilibrium with the amorphous metal alloy matrix. A stress level for transformation induced plasticity of the ductile metal particles may be at or below a shear strength of the amorphous metal alloy matrix. The second phase may comprise particles having a spacing between adjacent particles in the range of 0.1 to 20 micrometers. The second phase may comprise particles having a particle size in the range of from 0.1 to 15 micrometers. The second phase may comprise in the range of from 15 to 35 volume percent of the composite. The second phase may comprise a ductile metal alloy having an interface in chemical equilibrium with the amorphous metal matrix, and the composite may be free of a third phase. The composite may have a stress induced martensitic transformation.

A second embodiment is a fish hook formed at least in part of a composite material comprising: an amorphous metal alloy forming a substantially continuous matrix; a second ductile metal phase in the form of dendrites embedded in the matrix and formed in situ in the matrix by crystallization from a molten alloy; and wherein the dendrites have lengths of about 15 to 150 micrometers, the dendrites comprise secondary arms having widths of about 4 to 6 micrometers, and the secondary arms are spaced apart about 6 to 8 micrometers.

A third embodiment is a fish hook formed at least in part of a composite material comprising: an amorphous metal alloy forming a substantially continuous matrix; and a second ductile metal phase in the form of particles embedded in the matrix and formed in situ in the matrix by crystallization from a molten alloy; and wherein the particles have a particle size in the range of from 0.1 to 15 micrometers, spacing between adjacent particles in the range of 0.1 to 20 micrometers, the particles are in the range of from about 5 to 50 volume percent of the composite, the particles are sufficiently spaced apart for inducing a uniform distribution of shear bands traversing both the amorphous phase and the second phase and having a width of each shear band in the range of from 100 to 500 nanometers.

In another aspect, the present invention includes a method of making a fish hook comprising the step of forming a fish hook formed at least in part of a composite material comprising: an amorphous metal alloy forming a substantially continuous matrix; and a second ductile metal phase embedded in the matrix and formed in situ in the matrix by crystallization from a molten alloy. The forming step may comprise: providing a precursor of the composite material in molten form in a fish hook mold; and solidifying the precursor under conditions effective to form a fish hook comprising the composite material. The forming step may comprise forming a one-piece fish hook.

In another aspect, the present invention includes a method of fishing comprising the step of using a fish hook formed at least in part of a composite material comprising: an amorphous metal alloy forming a substantially continuous matrix; and a second ductile metal phase embedded in the matrix and formed in situ in the matrix by crystallization from a molten alloy.

### BRIEF DESCRIPTION OF THE DRAWINGS

The above mentioned and other advantages of the present invention, and the manner of attaining them, will become more apparent and the invention itself will be better understood by reference to the following description of the embodiments of the invention taken in conjunction with the accompanying drawings, wherein:

FIG. 1 is a multi-piece fish hook of the prior art;

FIG. 2 is a fish hook according to the present invention;

FIG. 3 is a schematic binary phase diagram;

FIG. 4 is a pseudo-binary phase diagram of an exemplary alloy system for forming a composite by chemical partitioning;

FIG. 5 is a phase diagram of a Zr—Ti—Cu—Ni—Be alloy system; and

FIG. 6 is a compressive stress-strain curve for an in situ composite of bulk-solidifying amorphous alloy.

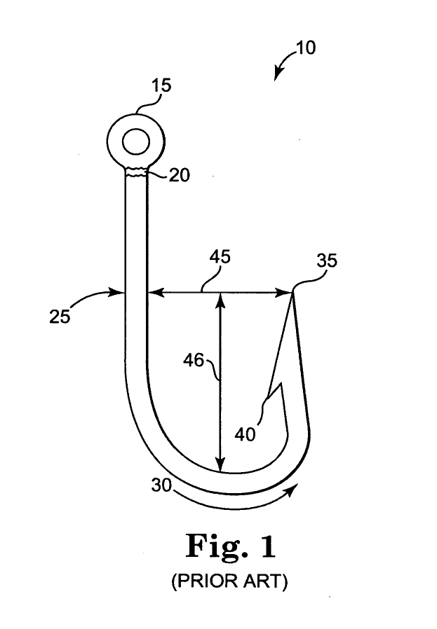

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention.

The present invention is directed to fish hooks wherein at least a portion of the device is formed of an amorphous metal alloy forming a substantially continuous matrix with a second ductile metal phase embedded in the matrix and formed in situ in the matrix by crystallization from a molten alloy. One example of such a bulk-solidifying amorphous alloy, as it may be called, is a ductile metal reinforced bulk metallic glass matrix composite.

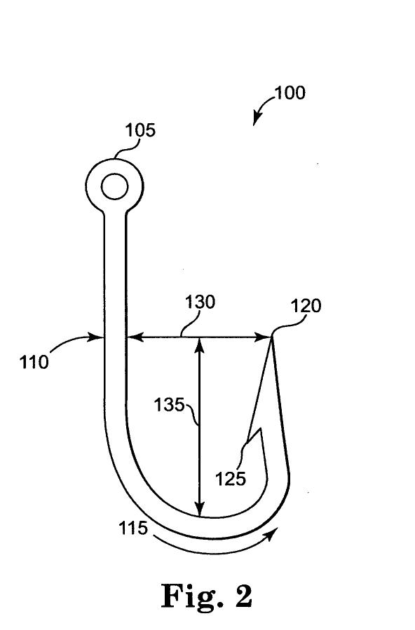

For purposes of illustration, FIG. 2 shows a preferred, representative fish hook 100 according to the present invention. As shown, fish hook 100 includes an eye 105, a shank 110, a bend 115, a point 120 and a barb 125. In general, two important dimensions of a fish nook are the gape 130 and/or the bite/throat 135. Gape 130 is the distance between point 120 and shank 110. Bite/throat 135 is the distance from the apex of bend 115 to its intersection with gape 130. The fish hook 100 is formed at least in part of an in situ composite of bulk-solidifying amorphous alloy. In situ composites of bulk-solidifying amorphous alloy are discussed in detail below.

In general, the eye of a fish hook includes many variations such as a bull/ringed eye, a tapered eye, a looped eye, a needle eye, and the like. A bull/ringed eye forms a circle and is probably the most common. A tapered eye forms a ring that decreases in diameter and is relatively more thin than the rest of the fish hook. A tapered eye is typically used for tying dry flies and for bait fishing, however, a tapered eye may be relatively more weak and may open or even break under pressure. A looped eye is oval in shape and may be tapered at the end. A needle eye is similar to the eye of a sewing needle. A needle eye is strong and tends to be used for big-game fishing. Also, the eye of a hook can be parallel (as in FIG. 2) or perpendicular to the plane of the hook. Further, fish hook eyes can be straight, bent forward, or bent backward. As shown, eye 105 is a ringed eye that is straight and parallel to the plane of the rest of hook 100.

The shank of a fish hook is the part of the hook which extends from the bend of the hook to the eye of the hook. The shank of a fish hook comes in a variety of shapes such as, e.g., straight, curved, or sliced. A straight fish hook shank is generally substantially straight from the eye of the hook to the bend of the hook. A curved fish hook shank is generally curved from the eye of the hook to the bend of the hook. A sliced shank has one or more barbs cut into the shank. The shank can be a variety of lengths, but typically come in sizes known as regular, short, or long. A regular shank tends to be used for “all-around” fishing. A short shank tends to be used to hide the hook inside bait so that a fish is less likely to see the hook. And a long shank tends to be used to hinder a fish from cutting the fishing line with its teeth and/or to hinder a fish from swallowing the hook and bait. As shown, shank 110 is a straight, regular shank.

In general, the point of a fish hook is a sharp end of the hook that penetrates a fish. A fish hook point preferably penetrates a fish with as little force as possible. Also, a fish hook point preferably stays sharp for a long period of time so as to preserve the utility and efficiency of the fish hook. A wide-variety of types of points are known such as, e.g., spear point, hollow point, needle point, rolled-in point, a knife-edge point, and diamond/triangle points. A spear point follows a straight line from a point to a barb. A hollow point is rounded out down to about the tip of the barb and tends to be thin and shallow. A rolled-in point is curved back towards the eye of the hook to allow for a direct line pull and is relatively more difficult for a fish to throw off. A needle point is rounded and narrows the point to the barb to resemble a claw. A knife-edge point has flat sides on the inside portion of the point. A diamond/triangle point has three cutting edges used to penetrate fish having relatively hard mouths. As shown, point 120 is a knife-edge point.

A fish hook barb is a projection extending, e.g., backwards from a point to help prevent the fish from unhooking after the point has penetrated the fish. Features of the barb such as barb angle and elevation help influence its holding ability. Similar to a fish hook point, a barb preferably maintains its features (e.g., maintains its angle and elevation) for a long period of time so as to preserve the utility and efficiency of the fish hook.

Fish hooks come in a variety of sizes determined by their pattern. Typically, a fish hook size is given in terms of the width of its gape (e.g., gape 130) of the hook. Commercial fishing hooks such as fish hook 100 are relatively large. A preferred commercial fish hook size is commonly known as size 12/0.

As discussed above in the Background, conventional fish hooks are made of multiple parts that are welded attached or otherwise attached. Such attachment points may break during use of the hooks. The fish hooks of the present invention may be made of multiple parts as well, however such a form is less preferred. A unitary fish hook is preferred.

A fish hook according to the present invention is made at least in part from an in situ composite of bulk-solidifying amorphous alloy.

A unique characteristic of an in situ composite of bulk-solidifying amorphous alloy, such as that commercially available from Liquidmetal Technologies of Lake Forest, Calif., U.S.A., is the availability of superior mechanical properties in as-cast form. This characteristic allows fish hooks of the present invention to be easily fabricated in a single piece using casting and/or other molding techniques.

In situ composite of bulk-solidifying amorphous alloy (or ductile metal reinforced bulk metallic glass matrix composite) has desirable properties such as high elastic strain limit, for example, up to 2%, and high yield strength, for example, up to 1.6 GPa, while providing tensile ductility, for example, up to 10%, and impact toughness, for example several times that of homogenous bulk-solidifying amorphous alloy. The in situ composite material also provides a low modulus of elasticity, in large part due to low modulus of the dendritic phase (which is an extended solid solution of primary phase of the main constituent element). For example, the Young Modulus of Zr-base alloy (e.g., VITRELOY-1™ (hereinafter “V-1”) from Liquidmetal Technologies) can be reduced from about 95 GPa down to 80 GPa in the in situ composite form.

The following describes the details and preparation of methods of in situ composites of bulk-solidifying amorphous alloy. The material exhibits both improved toughness and a large plastic strain to failure. It should be understood that the fish hooks of the present invention can be made of these matrix composite materials.

The remarkable glass-forming ability of bulk metallic glasses at low cooling rates (e.g., less than about 10³ K/sec) allows for the preparation of ductile metal reinforced composites with a bulk metallic glass matrix via in situ processing; i.e., chemical partitioning. The incorporation of a ductile metal phase into a metallic glass matrix yields a constraint that allows for the generation of multiple shear bands in the metallic glass matrix. This stabilizes crack growth in the matrix and extends the amount of strain to failure of the composite. Specifically, by control of chemical composition and processing conditions, a stable two-phase composite (ductile crystalline metal in a bulk metallic glass matrix) is obtained on cooling from the liquid state.

In order to form a composite amorphous metal object by chemical partitioning, one starts with a composition that may not, by itself, form an amorphous metal upon cooling from the liquid phase at reasonable cooling rates. Instead, the composition includes additional elements or a surplus of some of the components of an alloy that would form a glassy state on cooling from the liquid state.

A particularly attractive bulk glass-forming alloy system is described in U.S. Pat. No. 5,288,344, the disclosure of which is hereby incorporated by reference. For example, to form a composite having a crystalline reinforcing phase and an amorphous matrix, one may start with an alloy in a bulk glass-forming zirconium-titanium-copper-nickel-beryllium system with added niobium. Such a composition is melted so as to be homogeneous. The molten alloy is then cooled to a temperature range between the liquidus and solidus for the composition. This causes chemical partitioning of the composition into solid crystalline ductile metal dendrites and a liquid phase, with different compositions. The liquid phase becomes depleted of the metals crystallizing into the crystalline phase and the composition shifts to one that forms a bulk metallic glass at low cooling rate. Further cooling of the remaining liquid results in formation of an amorphous matrix around the crystalline phase.

Alloys suitable for practice of this invention have a phase diagram with both a liquidus and a solidus that each include at least one portion that is vertical or sloping, i.e., that is not at a constant temperature.

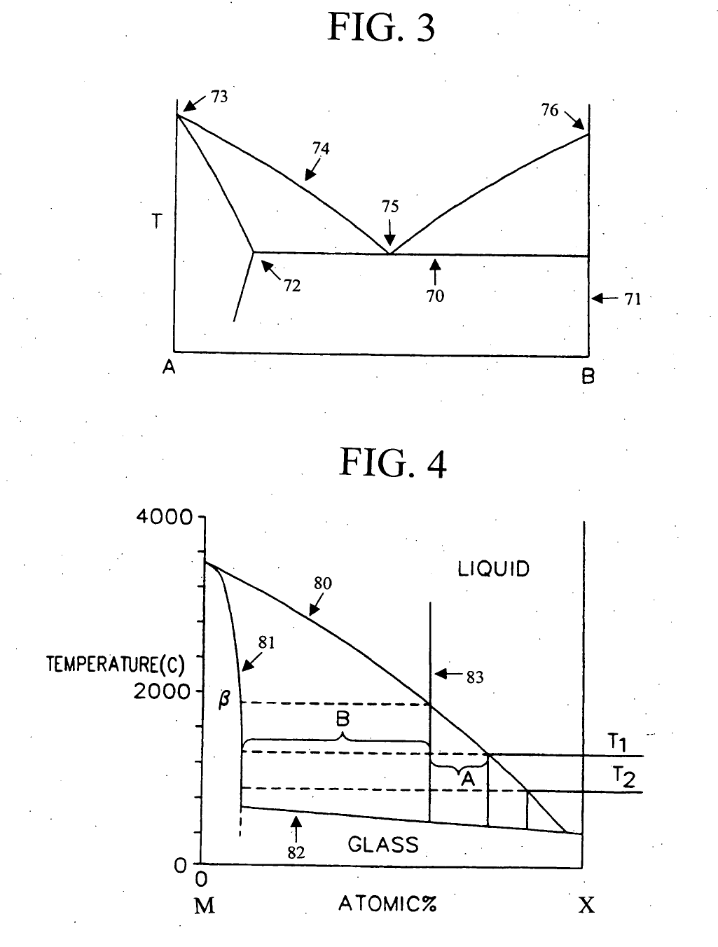

Consider, for example, a binary alloy, AB, having a phase diagram with a eutectic and solid solubility of one metal A in the other metal B as shown in FIG. 3. In such an alloy system the phase diagram has a horizontal or constant temperature solidus line 70 at the eutectic temperature extending from B 71 to a point 72 where B is in equilibrium with a solid solution of B in A. The solidus line 70 then slopes upwardly from the equilibrium point 72 to the melting point of A 73. The liquidus line 74 in the phase diagram extends from the melting point of A 73 to the eutectic composition 75 on the horizontal solidus 70 and from there to the melting point of B 76. Thus, the solidus 70 has a portion that is not at a constant temperature (between the melting point of A 73 and the equilibrium point 72). The vertical line from the melting point of B to the eutectic temperature could also be considered a solidus line where there is no solid solubility of A in B. Likewise, the liquidus 74 has sloping lines that are not at constant temperature. In a ternary alloy phase diagram there are solidus and liquidus surfaces instead of lines.

When referring to the solidus herein, it should be understood that this may not be entirely the same as the solidus in a conventional crystalline metal phase diagram, for example. In usage herein, the solidus refers in part to a line (or surface) defining the boundary between liquid metal and a solid phase. This usage is appropriate when referring to the boundary between the melt and a solid crystalline phase precipitated for forming the phase embedded in the matrix. For the glass-forming remainder of the melt the “solidus” is typically not at a well-defined temperature, but is where the viscosity of the alloy becomes sufficiently high that the alloy is considered to be rigid or solid. Knowing an exact temperature is not important.

Before considering alloy selection, we discuss the partitioning method in a pseudo-binary alloy system. FIG. 4 is a phase diagram for alloys of M and X where X is a good glass-forming composition, i.e., a composition that forms an amorphous metal at reasonable cooling rates. Compositions range from 100% M at the left margin to 100% of the alloy X at the right margin. An upper slightly curved line 80 is a liquidus for M in the alloy and a steeply curving line 81 near the left margin is a solidus for M with some solid solution of components of X in a body centered cubic (bcc) M alloy. A horizontal or near horizontal line 82 below the liquidus is, in effect, a solidus for an amorphous alloy. A vertical line 83 in mid-diagram is an arbitrary alloy where there is an excess of M above a composition that is a good bulk glass-forming alloy.

As one cools the alloy from the liquid, the temperature encounters the liquidus 80. A precipitation of bcc M (with some of the X components, principally titanium and/or zirconium, in solid solution) commences with a composition where a horizontal line from the liquidus encounters the solidus 81. With further cooling, there is dendritic growth of M crystals, depleting the liquid composition of M, so that the melt composition follows along the sloping liquidus line 80. Thus, there is a partitioning of the composition to a solid crystalline bcc, M-rich phase and a liquid composition depleted in M.

At an arbitrary processing temperature T₁ the proportion of solid M alloy corresponds to the distance A and the proportion of liquid remaining corresponds to the distance B in FIG. 4. In other words, about ¼ of the composition is solid dendrites and the other ¾ is liquid. At equilibrium at a second processing temperature T₂ somewhat lower than T₁, there is about ⅓ solid crystalline phase and ⅔ liquid phase.

If one cools the exemplary alloy to the first or higher processing temperature T₁ and holds at that temperature until equilibrium is reached, and then rapidly quenches the alloy, a composite is achieved having about ¼ particles of bcc alloy distributed in a bulk metallic glass matrix having a composition corresponding to the liquidus at T₁. One can vary the proportion of crystalline and amorphous phases by holding the alloy at a selected temperature above the solidus, such as for example, at T₂ to obtain a higher proportion of ductile metallic particles.

Instead of cooling and holding at a temperature to reach equilibrium as represented by the phase diagram, one is more likely to cool from the melt continuously to the solid state. The morphology, proportion, size and spacing of ductile metal dendrites in the amorphous metal matrix is influenced by the cooling rate. Generally speaking, a faster cooling rate provides less time for nucleation and growth of crystalline dendrites, so they are smaller and more widely spaced than for slower cooling rates. The orientation of the dendrites is influenced by the local temperature gradient present during solidification.

For example, to form a composite with good mechanical properties, and having a crystalline reinforcing phase embedded in an amorphous matrix, one may start with compositions based on bulk metallic glass-forming compositions in the Zr—Ti—M—Cu—Ni—Be system, where M is niobium. Alloy selection can be exemplified by reference to FIG. 4 which is a section of a pseudo-ternary phase diagram with apexes of titanium, zirconium and X, where X is Be₉Cu₅Ni₄.

There are at least two strategies for designing a useful composite of crystalline metal particles distributed in an amorphous matrix in this alloy system. Strategy 1 is based on systematic manipulations of the chemical composition of bulk metallic glass forming compositions in the Zr—Ti—Cu—Ni—Be system. Strategy 2 is based on the preparation of chemical compositions which comprise the mixture of additional pure metal or metal alloys with a good bulk metallic glass-forming composition in the Zr—Ti—Cu—Ni—Be system.

Strategy 1: Systematic Manipulation of Bulk Metallic Glass-Forming Compositions.

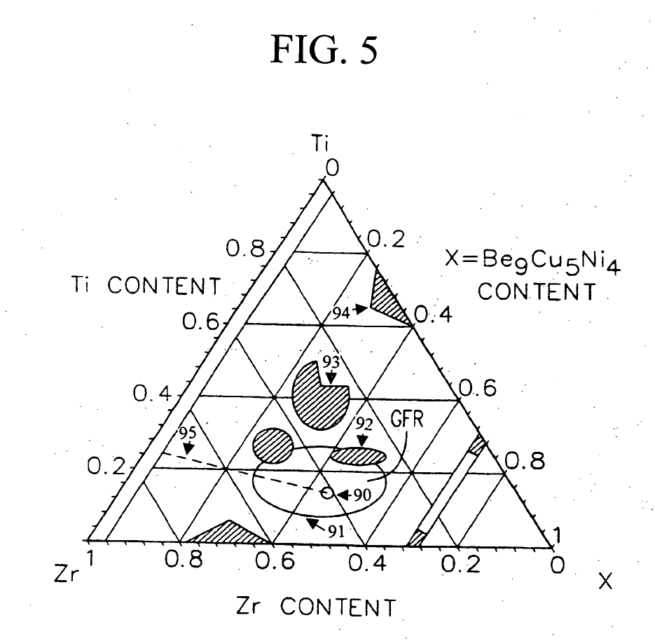

An excellent bulk metallic glass-forming composition has been developed with the following chemical composition: (Zr₇₅Ti₂₅)₅₅X₄₅=Zr_{41.2}Ti_{13.8}Cu_{12.5}Ni₁₀Be_{22.5} expressed in atomic percent, and herein labeled as alloy V1. This alloy composition has a proportion of Zr to Ti of 75:25. It is represented on the ternary diagram at the small circle 90 in the large oval 91 (FIG. 5).

Around the alloy composition V1 lies a large region of chemical compositions which form a bulk metallic glass object (an object having all of its dimensions greater than one millimeter) on cooling from the liquid state at reasonable rates. This bulk glass-forming region (GFR) is defined by the oval labeled 91 and GFR in FIG. 5. When cooled from the liquid state, chemical compositions that lie within this region are fully amorphous when cooled below the glass transition temperature.

The pseudo-ternary diagram shows a number of competing crystalline or quasi-crystalline phases which limit the bulk metallic glass-forming ability. Within the GFR these competing crystalline phases are destabilized, and hence do not prevent the vitrification of the liquid on cooling from the molten state. However, for compositions outside the GFR, on cooling from the high temperature liquid state the molten liquid chemically partitions. If the composition is alloyed properly, it forms a good composite engineering material with a ductile crystalline metal phase in an amorphous matrix. There are compositions outside GFR where alloying is inappropriate and the partitioned composite may have a mixture of brittle crystalline phases embedded in an amorphous matrix. The presence of these brittle crystalline phases seriously degrades the mechanical properties of the composite material formed.

For example, toward the upper right of the larger GFR oval, there is a smaller oval 92 partially overlapping the edge of the larger oval 91, and in this region a brittle Cu₂ZrTi phase may form on cooling the liquid alloy. This is an embrittling phenomenon and such alloys are not suitable for practice of this invention. The regions indicated on this pseudo-ternary diagram are approximate and schematic for illustrating practice of this invention.

Above the left part of large GFR oval 91 as illustrated in FIG. 5 there is a smaller circle 90 representing a region where a quasi-crystalline phase forms, another embrittling phenomenon. An upper partial oval 93 represents another region where a NiTiZr Laves phase forms. A small triangular region 94 along the Zr—X margin represents formation of intermetallic TiZrCu₂ and/or Ti₂Cu phases. Small regions near 70% X are compositions where a ZrBe₂ intermetallic or a TiBe₂ Laves phase forms. Along the Zr—Ti margin a mixture of and Zr or Zr—Ti alloy may be present.

To form a composite with good mechanical properties, a ductile second phase is formed in situ. Thus, the brittle second phases identified in the pseudo-ternary diagram are to be avoided. This leaves a generally triangular region toward the upper left from the Zr₄₂Ti₁₄X₄₄ circle where another metal M may be substituted for some of the zirconium and/or titanium to provide a composite with desirable properties. This is reviewed for a substitution of niobium for some of the titanium.

A dashed line 95 is drawn on FIG. 5 toward the 25% titanium composition on the Zr—Ti margin. In the series of compositions along the dashed line, (Zr₁₀₀₋ₓTi_{x-z}M_{z})_{100-y}((Ni₄₅Cu₅₅))₅₀Be₅₀)_{y} where M=Nb and x=25, increasing z means decreasing the amount of titanium from the original proportion of 75:25. In the portion of the dashed line 95 within the larger oval 91, the compositions are good bulk glass-forming alloys. Once outside the oval 91, ductile dendrites rich in zirconium form in a composite with an amorphous matrix. These ductile dendrites are formed by chemical partitioning over a wide range of z and y values.

For example, when z=3 and y=25, there is formation of phase. It has been shown that phase is formed when z=13.3, extending up to z=20 with y values surrounding 25. Excellent mechanical properties have been found for compositions in the range of z=5 to z=10, with a premier composition where z=about 6.66 along this 75:25 line when M is niobium.

It should be noted that one should not extend along the 75:25 dashed line 95 to less than about 5% beryllium, i.e., where y is less than 10. Below that there is little amorphous phase left and the alloy is mostly dendrites without the desirable properties of the composite.

Consider an alloy series of the form (Zr₁₀₀₁₀₀₋ₓTi_{x-z}M_{z})_{100-y}X_{y} where M is an element that stabilizes the crystalline phase in Ti- or Zr-based alloys and X is defined as before. To form an in situ prepared bulk metallic glass matrix composite material with good mechanical properties it is important that the secondary crystalline phase, preferentially nucleated on cooling from the high temperature liquid, be a ductile second phase. An example of an in situ prepared bulk metallic glass matrix composite which has exhibited outstanding mechanical properties has the nominal composition (Zr₇₅Ti_{18.34}Nb_{6.66})₇₅X₂₅; i.e., an alloy with M=Nb, z=6.66, x=18.34 and y=25. This is along the dashed line 95 of alloys in FIG. 5.

Peaks on an x-ray diffraction pattern for this composition show that the secondary phase present has a bcc or phase crystalline symmetry, and that the x-ray pattern peaks are due to the phase only. A Nelson-Riley extrapolation yields a phase lattice parameter a=3.496 Angstroms. Thus, upon cooling from the high temperature melt, the alloy undergoes partial crystallization by nucleation and subsequent dendritic growth of the ductile crystalline metal phase in the remaining liquid. The remaining liquid subsequently freezes to the glassy state producing a two-phase microstructure containing phase dendrites in an amorphous matrix.

SEM electron microprobe analysis gives the average composition for the phase dendrites (light phase in FIG. 5) to be Zr₇₁Ti_{16.3}Nb₁₀Cu_{1.8}Ni_{0.9}. Under the assumption that all of the beryllium in the alloy is partitioned into the matrix, we estimate that the average composition of the amorphous matrix (dark phase) is Zr₄₇Ti_{12.9}Nb_{2.8}Cu₁₁Ni_{9.6}Be_{16.7}. Microprobe analysis also shows that within experimental error (about ±1 at. %), the compositions within the two phases do not vary. This implies complete solute redistribution and the establishment of chemical equilibrium within and between the phases.

Differential scanning calorimetry analysis of the heat of crystallization of the remaining amorphous matrix compared with that of the fully amorphous sample gives a direct estimate of the molar fractions (and volume fractions) of the two phases. This gives an estimated fraction of about 25% phase by volume and about 75% amorphous phase. Direct estimates based on area analysis of the SEM image agree well with this estimate. The SEM image shows the fully developed dendritic structure of the phase. The dendritic structures are characterized by primary dendrite axes with lengths of 50-150 micrometers and radius of about 1.5-2 micrometers. Regular patterns of secondary dendrite arms with spacing of about 6-7 micrometers are observed, having radii somewhat smaller than the primary axis. The dendrite “trees” have a very uniform and regular structure. The primary axes show some evidence of texturing over the sample as expected since dendritic growth tends to occur in the direction of the local temperature gradient during solidification.

The relative volume proportion of the phase present in the in situ composite can be varied greatly by control of the chemical composition and the processing conditions. For example, by varying the y value in the alloy series along the dashed line in FIG. 5, (Zr₇₅Ti_{18.34}Nb_{6.66})_{100-y}X_{y}, with M=Nb; i.e., by varying the relative proportion of the early- and late-transition metal constituents; the resultant microstructure and mechanical behavior exhibited on mechanical loading changes dramatically. In situ composites in the Zr—Ti—M—Cu—Ni—Be system have been prepared for alloy series other than the series along the dashed line. These additional alloy series sweep out a region of the quinary composition phase space shown in FIG. 5. The region sweeps in a clockwise direction from a line (not shown) from the V1 alloy composition to the Zr apex of the pseudo-ternary diagram through the dashed line, and extending through to a line (not shown) from the V1 alloy to the Ti apex of the pseudo-ternary diagram, but excluding those regions where a brittle crystalline, quasi-crystalline or Laves phase is stable.

Strategy 2: The Preparation of In Situ Composites by the Mixture of Pure Metal or Metal Alloys with Bulk Metallic Glass-Forming Compositions.

As an additional example of the design of in situ composites by chemical partitioning, we discuss the following series of materials. These alloys are prepared by rule of mixture combinations of a metal or metal alloy with a good bulk metallic glass (BMG) forming composition. The formula for such a mixture is given by BMG(100−x)+M(x) or BMG(100−x)+Nb(x), where M=Nb. Preferably, in situ composite alloys of this form are prepared by first melting the metal or metallic alloy with the early transition metal constituents of the BMG composition. Thus, pure Nb metal is mixed via arc melting with the Zr and Ti of the V1 alloy. This mixture is then arc melted with the remaining constituents; i.e., Cu, Ni, and Be, of the V1 BMG alloy. This molten mixture, upon cooling from the high temperature melt, undergoes partial crystallization by nucleation and subsequent dendritic growth of nearly pure Nb dendrites, with phase symmetry, in the remaining liquid. The remaining liquid subsequently freezes to the glassy state producing a two-phase microstructure containing Nb rich beta phase dendrites in an amorphous matrix.

If one starts with an alloy composition-with an excess of approximately 25 atomic % niobium above a preferred composition (Zr_{41.2}Ti_{13.8}Cu_{12.4}Ni_{10.1}Be_{22.5}) for forming a bulk metallic glass, ductile niobium alloy crystals are formed in an amorphous matrix upon cooling a melt through the region between the liquidus and solidus. The composition of the dendrites is about 82% (atomic %) niobium, about 8% titanium, about 8.5% zirconium, and about 1.5% copper plus nickel. This is the composition found when the proportion of dendrites is about ¼ bcc phase and ¾ amorphous matrix. Similar behaviors are observed when tantalum is the additional metal added to what would otherwise be a V1 alloy. Besides niobium and tantalum, suitable additional metals which may be in the composition for in situ formation of a composite may include molybdenum, chromium, tungsten and vanadium.

The proportion of ductile bcc-forming elements in the composition can vary widely. Composites of crystalline bcc alloy particles distributed in a nominally V1 matrix have been prepared with about 75% V1 plus 25% Nb, 67% V1 plus 33% Nb (all percentages being atomic). The dendritic particles of bcc alloy form by chemical partitioning from the melt, leaving a good glass-forming alloy for forming a bulk metallic glass matrix.

Partitioning may be used to obtain a small proportion of dendrites in a large proportion of amorphous matrix all the way to a large proportion of dendrites in a small proportion of amorphous matrix. The proportions are readily obtained by varying the amount of metal added to stabilize a crystalline phase. By adding a large proportion of niobium, for example, and reducing the sum of other elements that make a good bulk metallic glass-forming alloy, a large proportion of crystalline particles can be formed in a glassy matrix.

It appears to be important to provide a two-phase composite and avoid formation of a third phase. It is clearly important to avoid formation of a third brittle phase, such as an intermetallic compound, Laves phase or quasi-crystalline phase, since such brittle phases significantly degrade the mechanical properties of the composite.

It may be feasible to form a good composite as described herein, with a third phase or brittle phase having a particle size significantly less than 0.1 micrometers. Such small particles may have minimal effect on formation of shear bands and little effect on mechanical properties.

In the niobium enriched Zr—Ti—Cu—Ni—Be system, the microstructure resulting from dendrite formation from a melt comprises a stable crystalline Zr—Ti—Nb alloy, with beta phase (bcc) structure, in a Zr—Ti—Nb—Cu—Ni—Be amorphous metal matrix. These ductile crystalline metal particles distributed in the amorphous metal matrix impose intrinsic geometrical constraints on the matrix that leads to the generation of multiple shear bands under mechanical loading.

Sub-standard size Charpy specimens were prepared from a new in situ-formed composite material having a total nominal alloy composition of Zr_{56.25}Nb₅Ti_{13.76}Cu_{6.875}Ni_{5.625}Be_{12.5}. These have demonstrated Charpy impact toughness numbers that are 250% greater than that of the bulk metallic glass matrix alone; 15 ft-lb. vs. 6 ft-lb. Bend tests have shown large plastic strain to failure values of about 4%. The multiple shear band structures generated during these bend tests have a periodicity of spacing equal to about 8 micrometers, and this periodicity is determined by the phase dendrite morphology and spacing. In some cast plates with a faster cooling rate, plastic strain to failure in bending has been found to be about 25%. Samples have been found that will sustain a 180° bend.

In a specimen after straining, shear bands traverse both the amorphous metal matrix phase and the ductile metal dendrite phase. The directions of the shear bands differ slightly in the two phases due to different mechanical properties and probably because of crystal orientation in the dendritic phase.

Shear band patterns as described occur over a wide range of strain rates. A specimen showing shear bands crossing the matrix and dendrites was tested under quasi-static loading with strain rates of about 10⁻⁴ to 10⁻³ per second. Dramatically improved Charpy impact toughness values show that this mechanism is operating at strain rates of 10³ per second, or higher.

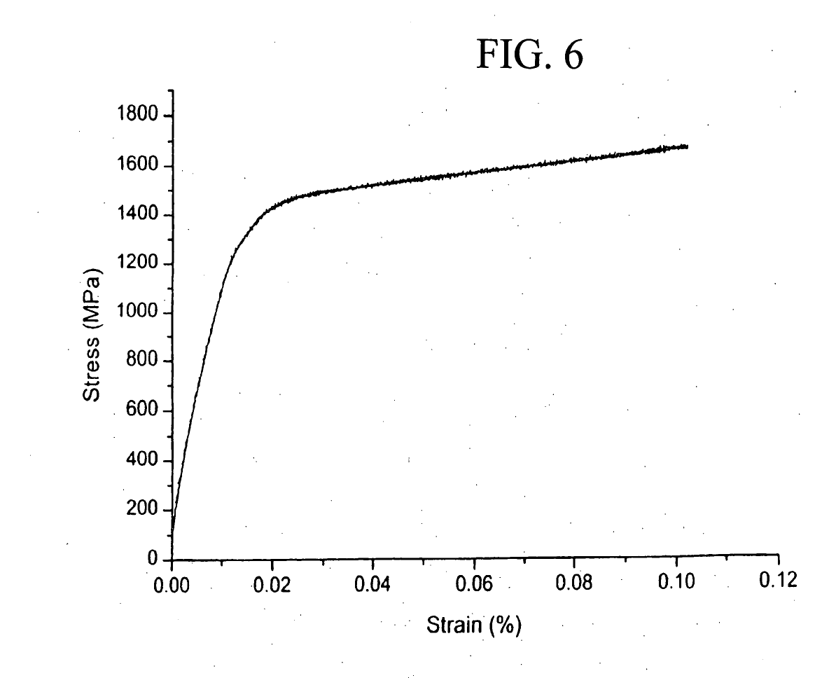

Specimens tested under compressive loading exhibit large plastic strains to failure on the order of 8%. An exemplary compressive stress-strain curve as shown in FIG. 6, exhibits an elastic-perfectly-plastic compressive response with plastic deformation initiating at an elastic strain of about 0.01. Beyond the elastic limit the stress-strain curve exhibits a slope implying the presence of significant work hardening. This behavior is not observed in bulk metallic glasses, which normally show strain-softening behavior beyond the elastic limit. These tests were conducted with the specimens unconfined, where monolithic amorphous metal would fail catastrophically. In these compression tests, failure occurred on a plane oriented at about 45° from the loading axis. This behavior is similar to the failure mode of the bulk metallic glass matrix. Plates made with faster cooling rates and smaller dendrite sizes have been shown to fail at about 20% strain when tested in tension.

One may also design good bulk glass-forming alloys with high titanium content as compared with the high zirconium content alloys described above. Thus, for example, in the Zr—Ti—M—Ni—Cu—Be alloy system a suitable glass-forming composition comprises (Zr₁₀₀₋ₓTi_{x-z}M_{z})_{100-y}((Ni₄₅Cu₅₅))₅₀Be₅₀)_{y} where x is in the range of from 5 to 95, y is in the range of from 10 to 30, z is in the range of from 3 to 20, and M is selected from the group consisting of niobium, tantalum, tungsten, molybdenum, chromium and vanadium. Amounts of other elements or excesses of these elements may be added for partitioning from the melt to form a ductile second phase embedded in an amorphous matrix.

Experimental results indicate that the beta phase morphology and spacing may be controlled by chemical composition and/or processing conditions. This in turn may yield significant improvements in the properties observed; e.g., fracture toughness and high-cycle fatigue. These results offer a substantial improvement over the presently existing bulk metallic glass materials.

Earlier ductile metal-reinforced bulk metallic glass matrix composite materials have not shown large improvements in the Charpy numbers or large plastic strains to failure. This is due at least in part to the size and distribution of the secondary particles mechanically introduced into the bulk metallic glass matrix. The substantial improvements observed in the new in situ-formed composite materials are manifest by the dendritic morphology, particle size, particle spacing, periodicity and volumetric proportion of the ductile beta phase. This dendrite distribution leads to a confinement geometry that allows for the generation of a large shear band density, which in turn yields a large plastic strain within the material.

Another factor in the improved behavior is the quality of the interface between the ductile metal beta phase and the bulk metallic glass matrix. In the new composites this interface is chemically homogeneous, atomically sharp and free of any third phases. In other words, the materials on each side of the boundary are in chemical equilibrium due to formation of dendrites by chemical partitioning from a melt. This clean interface allows for an iso-strain boundary condition at the particle-matrix interface; this allows for stable deformation and for the propagation of shear bands through the beta phase particles.

Thus, it is desirable to form a composite in which the ductile metal phase included in the glassy matrix has a stress induced martensitic transformation. The stress level for transformation induced plasticity, either martensite transformation or twinning, of the ductile metal particles is at or below the shear strength of the amorphous metal phase.

The ductile particles preferably have face centered cubic (fcc), bcc or hexagonal close-packed (hcp) crystal structures, and in any of these crystal structures there are compositions that exhibit stress-induced plasticity, although not all fcc, bcc or hcp structures exhibit this phenomenon. Other crystal structures may be too brittle or transform to brittle structures that are not suitable for reinforcing an amorphous metal matrix composite.

This new concept of chemical partitioning is believed to be a global phenomenon in a number of bulk metallic glass-forming systems; i.e., in composites that contain a ductile metal phase within a bulk metallic glass matrix, that are formed by in situ processing. For example, similar improvements in mechanical behavior may be observed in (Zr₁₀₀₋ₓTi_{x-z}M_{z})₁₀₀₋ₓ(X)_{y} materials, where X is a combination of late transition metal elements that leads to the formation of a bulk metallic glass; in these alloys X does not include Be.

It is important that the crystalline phase be a ductile phase to support shear band deformation through the crystalline phase. If the second phase in the amorphous matrix is an intrinsically brittle ordered intermetallic compound or a Laves phase, for example, there is little ductility produced in the composite material. Ductile deformation of the particles is important for initiating and propagating shear bands. It may be noted that ductile materials in the particles may work harden, and such work hardening can be mitigated by annealing, although it is important not to exceed a glass transition temperature that would lose the amorphous phase.

The particle size of the dendrites of crystalline phase can also be controlled during the partitioning. If one cools slowly through the region between the liquidus and processing temperature, few nucleation sites occur in the melt and relatively larger particle sizes can be formed. On the other hand, if one cools rapidly from a completely molten state above the liquidus to a processing temperature and then holds at the processing temperature to reach near equilibrium, a larger number of nucleation sites may occur, resulting in smaller particle size.

The particle size and spacing between particles in the solid phase may be controlled by cooling rate between the liquidus and solidus, and/or time of holding at a processing temperature in this region. This may be a short interval to inhibit excessive crystalline growth. The addition of elements that are partitioned into the crystalline phase may also assist in controlling particle size of the crystalline phase. For example, addition of more niobium apparently creates additional nucleation sites and produces finer grain size. This can leave the volume fraction of the amorphous phase substantially unchanged and simply change the particle size and spacing. On the other hand, a change in temperature between the liquidus and solidus from which the alloy is quenched can control the volume fraction of crystalline and amorphous phases. A volume fraction of ductile crystalline phase of about 25% appears near optimum.

In one example, the solid phase formed from the melt may have a composition in the range of from 67 to 74 atomic percent zirconium, 15 to 17 atomic percent titanium, 1 to 3 atomic percent copper, 0 to 2 atomic percent nickel, and 8 to 12 atomic percent niobium. Such a composition is crystalline, and would not form an amorphous alloy at reasonable cooling rates.

The remaining liquid phase has a composition in the range of from 35 to 43 atomic percent zirconium, 9 to 12 atomic percent titanium, 7 to 11 atomic percent copper, 6 to 9 atomic percent nickel, 28 to 38 atomic percent beryllium, and 2 to 4 atomic percent niobium. Such a composition falls within a range that forms amorphous alloys upon sufficiently rapid cooling.

Upon cooling through the region between the liquidus and solidus at a rate estimated at less than 50 K/sec, ductile dendrites are formed with primary lengths of about 50 to 150 micrometers. (Cooling was from one face of a one centimeter thick body in a water cooled copper crucible.) The dendrites have well-developed secondary arms in the order of four to six micrometers wide, with the secondary arm spacing being about six to eight micrometers. It has been observed in compression tests of such material that shear bands are equally spaced at about seven micrometers. Thus, the shear band spacing is coherent with the secondary arm spacing of the dendrites.

In other castings with cooling rates significantly greater, probably at least 100 K/sec, the dendrites are appreciably smaller, about five micrometers along the principal direction and with secondary arms spaced about one to two micrometers apart. The dendrites have more of a snowflake-like appearance than the more usual tree-like appearance. Dendrites seem less uniformly distributed and occupy less of the total volume of the composite (about 20%) than in the more slowly cooled composite. (Cooling was from both faces of a body 3.3 mm thick.) In such a composite, the shear bands are more dense than in the composite with larger and more widely spaced dendrites. It is estimated that in the first composite about four to five percent of the volume is in shear bands, whereas in the “finer grained” composite the shear bands are from two to five times as dense. This means that there is a greater amount of deformed metal, and this is also shown by the higher strain to failure in the second composite.

As used herein, when speaking of particle size or particle spacing, the intent is to refer to the width and spacing of the secondary arms of the dendrites, when present. In absence of a dendritic structure, particle size would have its usual meaning, i.e., for round or nearly round particles, an average diameter. It is also possible that acicular or lamellar ductile metal structures may be formed in an amorphous matrix. Width of such structures is considered as particle size. It will also be noted that the secondary arms in a dendritic are not uniform width; they taper from a wider end adjacent the principal axis toward a pointed or slightly rounded free end. Thus, the “width” is some value between the ends in a region where shear bands propagate. Similarly, since the arms are wider at the base, the spacing between arms narrows at that end and widens toward the tips. Shear bands seem to propagate preferentially through regions where the width and spacing are about the same magnitude. The dendrites are, of course, three-dimensional structures and the shear bands are more or less planar, so this is only an approximation.

When referring to particle spacing, the center-to-center spacing is intended, even if the text may inadvertently refer to the spacing in a context that suggests edge-to-edge spacing.

One may also control particle size by providing artificial nucleation sites distributed in the melt. These may be minute ceramic particles of appropriate crystal structure or other materials insoluble in the melt. Agitation may also be employed to affect nucleation and dendrite growth. Cooling rate techniques are preferred since repeatable and readily controlled.

It appears that the improved mechanical properties can be obtained from such a composite material where the second ductile metal phase embedded in the amorphous metal matrix, has a particle size in the range of from about 0.1 to 15 micrometers. If the particles are smaller than 100 nanometers, shear bands may effectively avoid the particles and there is little if any effect on the mechanical properties. If the particles are too large, the ductile phase effectively predominates and the desirable properties of the amorphous matrix are diluted. Preferably, the particle size is in the range of from 0.5 to 8 micrometers since the best mechanical properties are obtained in that size range. The particles of crystalline phase should not be too small or they are smaller than the width of the shear bands and become relatively ineffective. Preferably, the particles are slightly larger than the shear band spacing.

The spacing between adjacent particles are preferably in the range of from 0.1 to 20 micrometers. Such spacing of a ductile metal reinforcement in the continuous amorphous matrix induces a uniform distribution of shear bands throughout a deformed volume of the composite, with strain rates in the range of from about 10⁻⁴ to 10³ per second. Preferably, the spacing between particles is in the range of from 1 to 10 micrometers for the best mechanical properties in the composite.

The volumetric proportion of the ductile metal particles in the amorphous matrix is also significant. The ductile particles are preferably in the range of from 5 to 50 volume percent of the composite, and most preferably in the range of from 15 to 35% for the best improvements in mechanical properties. When the proportion of ductile crystalline metal phase is low, the effects on properties are minimal and little improvement over the properties of the amorphous metal phase may be found. On the other hand, when the proportion of the second phase is large, its properties dominate and the valuable assets of the amorphous phase are unduly diminished.

There are circumstances, however, when the volumetric proportion of amorphous metal phase may be less than 50% and the matrix may become a discontinuous phase. Stress induced transformation of a large proportion of in situ-formed crystalline metal modulated by presence of a smaller proportion of amorphous metal may provide desirable mechanical properties in a composite.

The size of and spacing between the particles of ductile crystalline metal phase preferably produces a uniform distribution of shear bands having a width of the shear bands in the range of from about 100 to 500 nanometers. Typically, the shear bands involve at least about four volume percent of the composite material before the composite fails in strain. Small spacing is desirable between shear bands since ductility correlates to the volume of material within the shear bands. Thus, it is preferred that there be a spacing between shear bands when the material is strained to failure in the range of from about 1 to 10 micrometers. If the spacing between bands is less than about ½ micrometer or greater than about 20 micrometers, there is little toughening effect due to the particles. The spacing between bands is preferably about two to five times the width of the bands. Spacing of as much as 20 times the width of the shear bands can produce engineering materials with adequate ductility and toughness for many applications.

In one example, when the band density is about 4% of the volume of the material, the energy of deformation before failure is estimated to be in the order of 23 joules (with a strain rate of about 10² to 10³/sec in a Charpy-type test). Based on such estimates, if the shear band density were increased to 30 volume percent of the material, the energy of deformation rises to about 120 joules.

For alloys usable for making objects with dimensions larger than micrometers, cooling rates from the region between the liquidus and solidus of less than 1000 K/sec are desirable. Preferably, cooling rates to avoid crystallization of the glass-forming alloy are in the range of from 1 to 100 K/sec or lower. For identifying acceptable glass-forming alloys, the ability to form layers at least 1 millimeter thick has been selected. In other words, an object having an amorphous metal alloy matrix has a thickness of at least one millimeter in its smallest dimension.

Optionally, one or more additives can be used in an in situ composite of bulk-solidifying amorphous alloy. In preferred embodiments, at least 5 percent, preferably 75 percent, even more preferably 90 percent, even more preferably substantially all of the material in the fish hook according to the present invention is an in situ composite of bulk-solidifying amorphous alloy.

A fish hook according to the present invention can be made using methods known or yet to be discovered. Practical and cost-effective methods to produce one or more fish hooks made out of material including an in situ composite of bulk-solidifying amorphous alloy, and particularly for fish hooks having intricate and precision shapes include metal mold casting methods, such as high-pressure die-casting, as these methods provide suitable cooling rates. Suitable methods to cast metallic glass fish hooks are disclosed in, e.g., U.S. Pat. Nos. 5,213,148; 5,279,349; 5,711,363; 6,021,840; 6,044,893; and 6,258,183, and U.S. Pub. No. 2003/0075246 (each of whose disclosures is incorporated herein by reference in its entirety). Optionally, casting a fish hook of the present invention can be carried out under an inert atmosphere or in a vacuum.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

What is claimed is:

1. A fish hook formed at least in part of a composite material comprising: an amorphous metal alloy forming a substantially continuous matrix; and a second ductile metal phase embedded in the matrix and formed in situ in the matrix by crystallization from a molten alloy.

2. The fish hook of claim 1, wherein the second phase is formed from a molten alloy having an original composition in the range of from 52 to 68 atomic percent zirconium, 3 to 17 percent titanium, 2.5 to 8.5 atomic percent copper, 2 to 7 atomic percent nickel, 5 to 15 percent beryllium, and 3 to 20 percent niobium.

3. The fish hook of claim 1, wherein the second phase is sufficiently spaced apart for inducing a uniform distribution of shear bands throughout a deformed volume of the composite, the shear bands involving at least four volume percent of the composite before failure in strain and traversing both the amorphous metal alloy matrix and the second phase.

4. The fish hook of claim 3, wherein the second phase is in the form of dendrites.

5. The fish hook of claim 3, wherein the second phase has a modulus of elasticity less than the modulus of elasticity of the amorphous metal alloy.

6. The fish hook of claim 3, wherein the ductile metal particles of the second phase are sufficiently spaced apart for inducing a uniform distribution of shear bands traversing both the amorphous phase and the second phase and having a width of each shear band in the range of from 100 to 500 nanometers.

7. The fish hook of claim 3, wherein the second phase has an interface in chemical equilibrium with the amorphous metal alloy matrix.

8. The fish hook of claim 3, wherein a stress level for transformation induced plasticity of the ductile metal particles is at or below a shear strength of the amorphous metal alloy matrix.

9. The fish hook of claim 1, wherein the second phase comprises particles having a spacing between adjacent particles in the range of 0.1 to 20 micrometers.

10. The fish hook of claim 1, wherein the second phase comprises particles having a particle size in the range of from 0.1 to 15 micrometers.

11. The fish hook of claim 1, wherein the second phase comprises in the range of from 15 to 35 volume percent of the composite.

12. The fish hook of claim 1, wherein the second phase comprising a ductile metal alloy has an interface in chemical equilibrium with the amorphous metal matrix, and the composite is free of a third phase.

13. The fish hook of claim 1, wherein the composite has a stress induced martensitic transformation.

14. A fish hook formed at least in part of a composite material comprising: an amorphous metal alloy forming a substantially continuous matrix; a second ductile metal phase in the form of dendrites embedded in the matrix and formed in situ in the matrix by crystallization from a molten alloy; and wherein the dendrites have lengths of about 15 to 150 micrometers, the dendrites comprise secondary arms having widths of about 4 to 6 micrometers, and the secondary arms are spaced apart about 6 to 8 micrometers.

15. A fish hook formed at least in part of a composite material comprising: an amorphous metal alloy forming a substantially continuous matrix; and a second ductile metal phase in the form of particles embedded in the matrix and formed in situ in the matrix by crystallization from a molten alloy; and wherein the particles have a particle size in the range of from 0.1 to 15 micrometers, spacing between adjacent particles in the range of 0.1 to 20 micrometers, the particles are in the range of from about 5 to 50 volume percent of the composite, the particles are sufficiently spaced apart for inducing a uniform distribution of shear bands traversing both the amorphous phase and the second phase and having a width of each shear band in the range of from 100 to 500 nanometers.

16. A method of making a fish hook comprising the step of forming a fish hook formed at least in part of a composite material comprising: an amorphous metal alloy forming a substantially continuous matrix; and a second ductile metal phase embedded in the matrix and formed in situ in the matrix by crystallization from a molten alloy.

17. The method of claim 16, wherein the forming step comprises:
providing a precursor of the composite material in molten form in a fish hook mold; and
solidifying the precursor under conditions effective to form a fish hook comprising the composite material.

18. The method of claim 16, wherein the forming step comprises forming a one-piece fish hook.

19. A method of fishing comprising the step of using a fish hook formed at least in part of a composite material comprising: an amorphous metal alloy forming a substantially continuous matrix; and a second ductile metal phase embedded in the matrix and formed in situ in the matrix by crystallization from a molten alloy.
